(19) United States
(12) Patent Application Publication
(10) Pub. No.: US 2025/0243624 A1
(43) Pub. Date: Jul. 31, 2025

(54) Adjustably Retractable Tether and Related Methods

(71) Applicant: Rob's Super Safe Surf Ropes, LLC, West Jordan, UT (US)

(72) Inventor: Robbie Hargis, West Jordan, UT (US)

(21) Appl. No.: 18/426,006

(22) Filed: Jan. 29, 2024

(51) Int. Cl. D07B 1/16; F16G 11/12

(52) U.S. Cl. CPC D07B 1/162; D07B 2401/2005; F16G 11/12

(57) ABSTRACT

An adjustable tether for providing a connection between two points includes a flexible sheath with at least one sidewall and a plurality of openings formed through the sidewall. A conduit portion is at least partially circumscribed by the at least one sidewall. An elastic member extends from a first portion of the sheath through the conduit portion of the sheath, and out of a first opening in the sidewall. The elastic member and the flexible sheath are each elastically extendible from a retracted configuration having a retracted length to a taut configuration having a taut length. The elastic member carries at least one hook having a gape, a bend and a throat defined between the gape and the bend, the hook operable to engage a material of the sidewall adjacent the first opening to prevent or limit the hook from moving relative to the sidewall.

### BACKGROUND OF THE INVENTION

### Field of the Invention

The present invention relates generally to retractable tethers used in a variety of applications to secure one or more objects. Tethers in accordance with the present technology can be used when walking pets, to secure workers or goods in industrial applications, to secure loads to or within vehicles, etc.

### Related Art

Many athletic, recreational, construction and industrial applications require a user to be engaged with another being, a structure or a vehicle via a tether or strap. In some cases, an application requires such tethers to temporarily extend when the distance between the connection points increases, and relax when the distance between the connection points decreases. Managing the length of the tether in such situations can be problematic.

### SUMMARY OF THE INVENTION

In accordance with one aspect of the technology, an adjustable tether is provided to allow a connection between two points. The tether can include a flexible sheath having at least one sidewall and a plurality of openings formed through the sidewall, and a conduit portion at least partially circumscribed by the at least one sidewall. An elastic member can extend from a first portion of the sheath through the conduit portion of the sheath, and out of a first opening in the sidewall. The elastic member and the flexible sheath can each being elastically extendible from a retracted configuration having a retracted length to a taut configuration having a taut length, the taut length being greater than the retracted length. The elastic member can carry at least one hook having a gape, a bend and a throat defined between the gape and the bend. The hook can be operable to engage a material of the sidewall adjacent the first opening to prevent or limit the hook from moving relative to the sidewall.

In accordance with another aspect of the technology, an adjustable tether is provided to allow a connection between two points. The tether can include a flexible sheath having at least one sidewall and a plurality of openings formed through the sidewall, and a conduit portion at least partially circumscribed by the at least one sidewall. An elastic member can extend from a first portion of the sheath through the conduit portion of the sheath, and out of a first opening in the sidewall. The elastic member and the flexible sheath can each be elastically extendible from a retracted configuration having a retracted length to a taut configuration having a taut length, the taut length being greater than the retracted length. The elastic member can carry at least one hook formed from a substantially rigid material, the hook having a gape, a bend and a throat defined between the gape and the bend, the gape being smaller than a maximum opening size of the throat. The hook can be operable to engage a material of the sidewall adjacent the first opening to prevent or limit the hook from moving relative to the sidewall.

In accordance with another aspect of the technology, a method is provided of adjusting a retracted length of an adjustable tether. The tether can have an elastic member and a flexible sheath with at least one sidewall and a plurality of openings formed through the sidewall and a conduit portion at least partially circumscribed by the at least one sidewall. The method can include positioning a first hook within the conduit portion in a first position along a length of the flexible sheath adjacent a first opening in the sidewall. The first hook can be advanced within the conduit portion to a second position further along the length of the flexible sheath than the first position. The first hook can be advanced through a second opening in the sidewall until the gape of the first hook has passed through the sidewall. A portion of the first hook can be retracted within the conduit portion until a portion of the sidewall of the sheath adjacent the second opening is contained within the throat of the first hook and the first hook is thereby secured to the sheath in the second position.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a perspective view of an adjustable tether in accordance with one aspect of the technology, shown in a relaxed or retracted configuration;

FIG. 2 is a perspective view of an elastic member of the adjustable tether of FIG. 1, shown in a relaxed or retracted configuration;

FIG. 3A is a perspective view of a hook of the elastic member of FIG. 2;

FIG. 3B is a side view of the hook of FIG. 3A;

FIGS. 4A and 4B are simplified side views of the hook of FIG. 3A, with a portion of a sheath about the hook shown in FIG. 4B;

FIG. 5 is a perspective view of the adjustable tether, with a portion of the elastic member extending from a sheath thereof;

FIG. 6 is another perspective view of the adjustable tether, with the elastic member retracted further inside the sheath; and

FIG. 7 is another perspective of the adjustable tether, with a hook portion of the elastic member cinched or engaging the sheath portion.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

### Definitions

As used herein, the singular forms “a” and “the” can include plural referents unless the context clearly dictates otherwise. Thus, for example, reference to “an opening” can include one or more of such openings, if the context so dictates.

As used herein, the term “substantially” refers to the complete or nearly complete extent or degree of an action, characteristic, property, state, structure, item, or result. As an arbitrary example, an object that is “substantially” enclosed is an article that is either completely enclosed or nearly completely enclosed. The exact allowable degree of deviation from absolute completeness may in some cases depend upon the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. As another arbitrary example, a composition that is “substantially free of” an ingredient or element may still actually contain such item so long as there is no measurable effect as a result thereof.

As used herein, the term “about” is used to provide flexibility to a numerical range endpoint by providing that a given value may be “a little above” or “a little below” the endpoint.

As used herein, the term “hook” is understood to refer to an open hook, or slip hook—that is, a hook that includes an opening through which material can be moved to reach the throat of the hook. Thus, an open hook will include a wall circumscribing the throat, but also an opening or discontinuity in the wall that allows material to pass through that wall into the throat. This is in contrast to a closed hook, in which a wall completely surrounds a throat area and material can only enter the throat area by being directly placed into the throat.

Relative terms relating to rigidity or flexibility can sometimes be used herein to describe and claim various components. As those words are used herein, they refer to the conditions of a material in ordinary operating conditions. Thus, a “flexible” material will be easily bent or twisted or folded by a human manipulating the material. In contrast, an ordinary human in ordinary conditions will not be able to deform or bend a “rigid” material. During normal operation of the tethers described herein, a rigid material will not change shape or configuration, while a flexible material will.

Relative directional terms can sometimes be used herein to describe and claim various components of the present invention. Such terms include, without limitation, “upward,” “downward,” “horizontal,” “vertical,” “proximal,” “distal,” etc. These terms are generally not intended to be limiting, but are used to most clearly describe and claim the various features of the invention. Where such terms must carry some limitation, they are intended to be limited to usage commonly known and understood by those of ordinary skill in the art in the context of this disclosure.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

### Invention

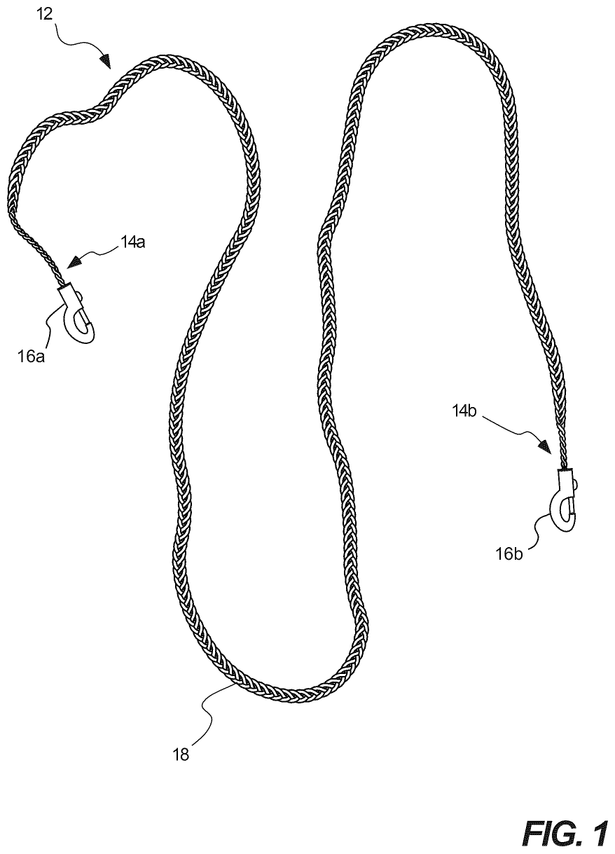

The present technology relates generally to tethers or similar securements that can be used between two or more attachment points. Tethers in accordance with the present technology can be used to connect persons to objects, or vice versa, objects to structures, or, in one specific example, one or more animals to persons walking or handling the animals. In the example shown in FIG. 1, tether 12 includes two opposite ends, 14a, 14b, that are provided by example with generic securement clasps 16a, 16b. These clasps can be used to attach the tether to a number other items. The clasps shown are merely exemplary: the tether can be provided with any known similar devices, such buckles, clips, hooks, etc.

In one particular example, the tether shown is well suited for use as a dog leash. In this application, one clasp 16a can be easily secured to a dog's collar, and the opposing clasp 16b can be attached to some structure on the person walking the dog, such as a belt or harness specifically provided for this use. Alternatively, the end of the tether to which clasp 16b is attached can be wrapped about the person's waist, and clasp 16b can be attached to the tether at the point where the tether completes its wrap, thereby secured about the user's waist. A suitable clip can be attached to the tether at this point, if desirable, to provide a location to easily attach the clasp end to the mid portion of the tether. This can provide a so-called “hands-free” leash to allow the person to walk the dog without requiring that he or she maintain a constant handhold on the leash.

In addition to the hands-free example provided above, the tether can also be provided with a standard loop on one end to provide a location for a person to hold the leash in his or hand. Thus, while reference may be made herein to “attaching” or “tethering” a user to some other structure, it is understood that the user may in some embodiments actively participate in such attachment by grasping or holding the tether in his or her hand. As such, in the discussion to follow, if a user is grasping a handle of a tether with his or hand, and the tether is coupled to some other structure or being, the user is considered to be connected or attached to that other structure or being.

The tethers discussed herein provide a notable advantage in that they can extend and contract between a taut configuration and a relaxed or retracted configuration. By retracting when no longer extended, the tethers can avoid tangling and unwanted coils of unused tether: instead, the tether simply shortens (and possibly thickens) as it retracts upon itself. This can be particularly advantageous for hands-free dog walking, as the person need not manage slack in the leash as the dog alternately moves further and closer to the person.

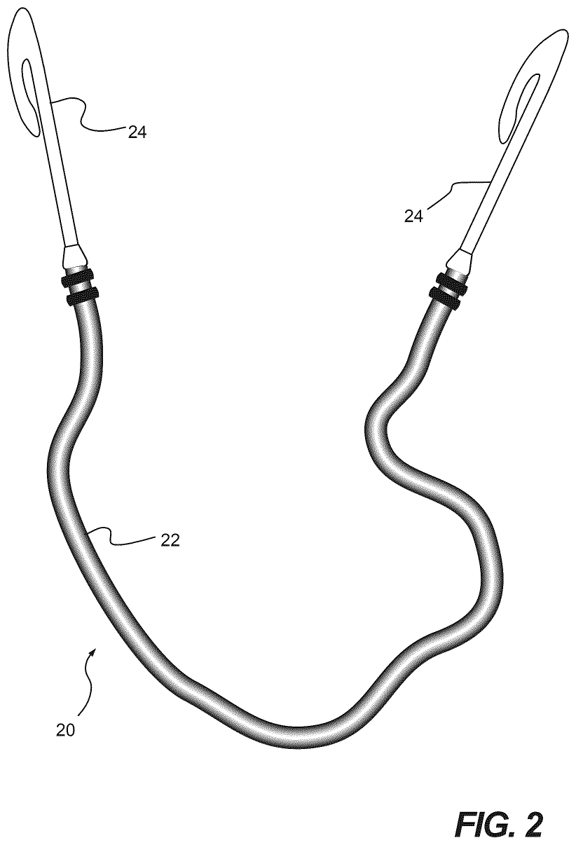

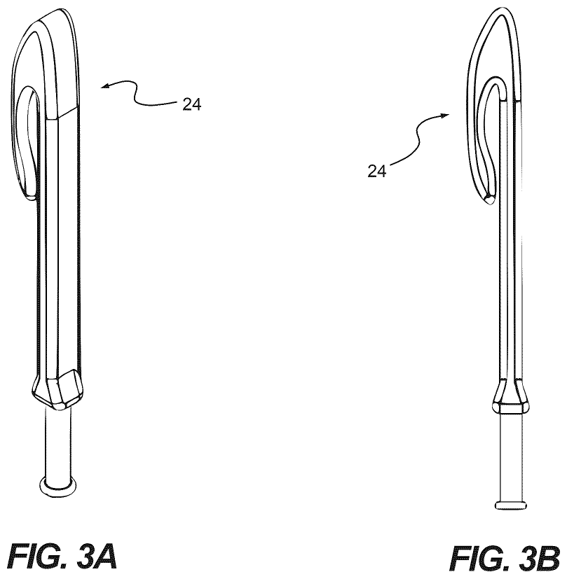

While the tether can be made from a variety of suitable materials, in one example the tether includes a flexible sheath 18, which in the embodiment shown is the outer visible portion. An elastic member 20 can be provided that, in one embodiment, is fitted within the sheath and, when properly attached to the sheath, tends to return the sheath to a nominal length of the elastic member. One exemplary elastic member 20 is shown in FIG. 2 and can include an elastic body 22 and a pair of hooks 24 attached at opposite ends of the elastic body.

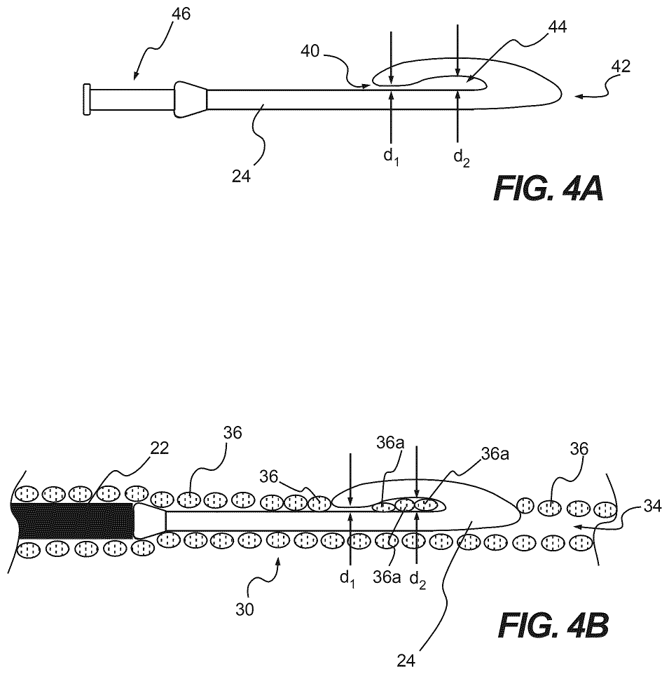

In one example, the sheath 18 can be formed from or include a hollow braid polyethylene rope, such as a ⅝ inch polyethylene hollow core 12 strand rope. As is generally known, such ropes are formed from braiding a series of individual strands in a manner that results in an internal core area remaining hollow after formation of the rope. The elastic body can be formed from an elastic tubular member, similar to the material commonly referred to as surgical tubing. In one example, the elastic body is formed from a latex rubber tubing with a 5/16 inch outer diameter and a 3/16 inner diameter (forming a wall thickness of ⅛ inch). The hook 24 can include a recessed area (46 in FIG. 4A) over which the elastic body 22 can be positioned and cinched into place with crimp rings or the like.

The hooks 24 shown provide a manner of adjustably attaching the elastic member 20 to (or within) the sheath. The elastic member is shown in FIG. 2 in a relaxed or retracted condition: this is a nominal length of the elastic member. If force is applied to the ends of the member, it will stretch a considerable amount. However, assuming only elastic deformation has occurred, once the force is removed, the elastic member will return to this nominal length. While the sheath is flexible and can be extended into a taut condition (which generally corresponds to a maximum length of the tether), any restoring force in the sheath is minimal compared to the elastic member. If, however, the elastic member is coupled to the sheath, the elastic member can apply enough force to pull the sheath with it as it returns to the retracted or relaxed length. Thus, while the sheath alone can be pulled into a taut condition, once the force applied to do so is removed, it will relax very little and shorten only slightly without the elastic member connected thereto.

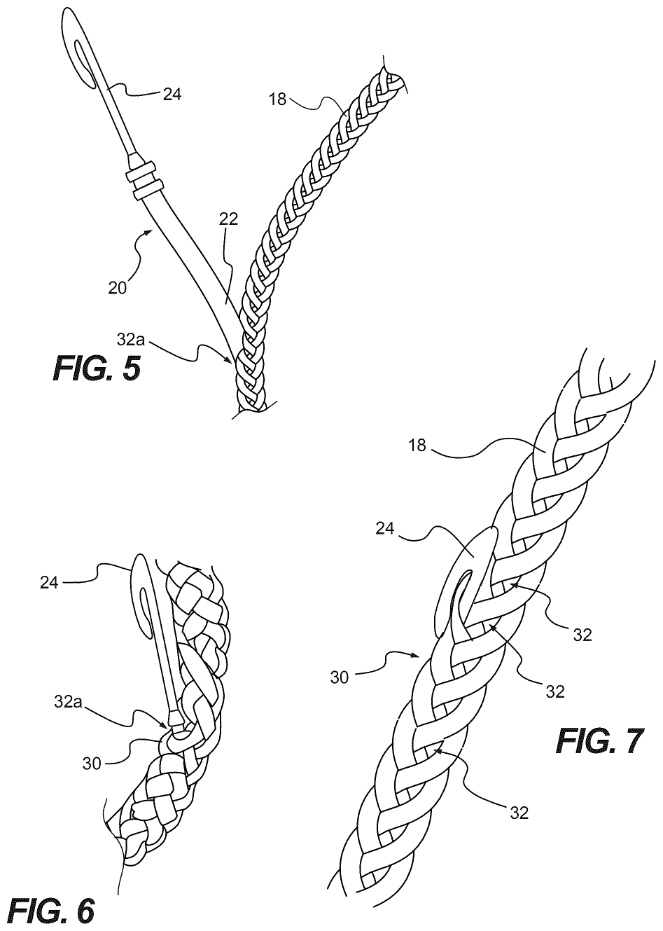

The present technology provides a manner by which the sheath 18 and the elastic member 20 can be adjustably coupled to one another to provide a retractable tether that can extend and retract automatically during use. The flexible sheath can include at least one sidewall 30 (note that when a hollow core rope is used, the sheath includes a single, tubular sidewall). The sidewall can include a plurality of openings 32 formed therethrough. FIG. 4B schematically illustrates the sidewall 30, with the numerous openings 32 being apparent in FIG. 7. A conduit portion (shown schematically at 34 in FIG. 4B, with much of the conduit portion being substantially filled by the hook 24) can be at least partially circumscribed by the sidewall. In operation, the elastic member 20 can extend from a first portion of the sheath through the conduit portion of the sheath, and out of a first opening in the sidewall. See, for example, FIG. 5 in which the elastic body 22 extends from opening 32a in the sheath 18.

As shown in FIGS. 4A and 4B, the hook 24 can include a gape 40, a bend 42 and a throat 44 defined between the gape and the bend. While not so required, in one aspect, the hook can be formed of a substantially rigid material. This can aid in retaining the features described, and in manipulating the hook within the hollow core of the sheath. In one embodiment, the hook is formed from a thermoplastic polyester, such as polyethylene terephthalate glycol, or PETG. Thus, in one embodiment, the hook includes a substantially rigid wall that circumscribes the throat, the wall being interrupted by a gape that allows material to enter the throat (the gape forming a discontinuity in the wall).

The specific size and geometry of the hook can be selected to optimize cooperation between the elastic member with the sheath. For example, in one embodiment, the gape 40 of the hook 24 can be smaller than a maximum opening size of the throat 44 of the hook. In one nonlimiting example, an overall length of the hook can be about 10 cm. In this case, the gape can be on the order of about 1.5 mm (see d₁ in FIG. 4B), with a maximum size of the throat opening being about 3 mm (see d₂ in FIG. 4B). Thus, the gape provides a location of restriction-both restricting passing of the sheath material into the throat, and restricting passage of the sheath material out of the throat. This can be advantageous in that the hook will resist becoming dislodged from the sheath material when the tether slackens or retracts, even if the elastic member is not applying a large degree of force to the hook.

FIG. 4B illustrates schematically the cooperation between the sidewall 30 of the sheath and hook 24, after the hook has been engaged with the sidewall (e.g., in the configuration shown in FIG. 7). The sidewall can be formed from a number of braided strands, each shown schematically at 36. As the hook is forced over the strands (or, put another way, as the strands are forced through the gape of the hook), they can tend to bunch up within the throat 44, as shown by strands 36a of FIG. 4B. In one embodiment, the gape is smaller than a nominal or relaxed thickness of the strands of the sidewall, in both a taut and in a relaxed condition. In another embodiment, the gape is smaller than a nominal or relaxed thickness of a section of the sidewall, which may include two or more overlapping strands. In this manner, the hook is securely engaged with the sidewall of the sheath and resists the tendency to slide off the sidewall. A user, however, can still relatively easily force the hook back through the opening 32 in the sidewall (and off of the strands 36a) to remove the hook from its position to enable the hook to be repositioned in a different opening in the sheath/sidewall.

In addition, as will be appreciated, a size of the various openings (32 in FIG. 7) in the sheath 30 can be smaller when the sheath is in the taut configuration and can expand when the sheath is in the retracted configuration. This further aids in securing the hook in position when engaged with the sheath, even in the absence of a force applied by the elastic member (e.g., when in a relaxed condition). Both the taut size of the first opening and the retracted size of the first opening can be smaller than the outer diameter of the hook. Due to the flexibility in the sidewall, however, any of the openings can be expanded to a size large enough to allow the hook to be passed through the opening.

As also shown in FIG. 4B, in one embodiment, the conduit portion 34 can include a taut inner diameter when the sheath 30 is in the taut configuration, the taut inner diameter being less than an outer diameter of the hook 24. In one example, the maximum outer diameter of the hook is about 1 cm. By oversizing the hook relatative to the conduit portion, the overall size of the sheath is minimized and the hook can be held snugly within the conduit portion when not being used. However, as the sheath is flexible, the diameter of the conduit portion can be expanded by forcing the hook along the length of the conduit to allow a user to adjust the position of the hook along the length of the sheath. The rounded shape of the bend 42 of the hook allows a user to feed the hook through the conduit portion.

In one embodiment, the elastic member 20 can include a single hook carried on or adjacent an end of the elastic body 22. In this case, an opposite end of the elastic member can be fixed or otherwise attached to the tether in a more or less permanent condition, or in some manner of attachment that differs from the hooks shown.

Adjustment of the retracted length of the tether can then be accomplished by adjusting a relative position of the single hook along the length of the tether. In another embodiment, the elastic member can include a pair of hooks coupled to opposite ends of the elastic body, as shown in FIG. 2. This arrangement can be advantageous in that the user can then adjust the position along the tether at which he or she wishes to provide retractability. In other words, the location of the entire elastic member can be repositioned relative to the sheath.

The user can, for example, leave one end of the tether with a non-retractable sheath; for example, the end that wraps about his or her waist during a hands-free leash configuration. In this case, the section of the tether extending from the user to the dog can be retractable, but the section of the tether about the user's waist need not be. When the tether includes two hooks, the arrangement shown in FIG. 4B can be replicated for both hooks.

In addition to the structure discussed above, the present technology also provides various methods for adjusting a tether, using a tether, installing a tether, etc.

In one example, some of which is shown in progression through FIGS. 5, 6 and 7, a method is provided of adjusting a retracted length of an adjustable tether. The tether in this example can have an elastic member and a flexible sheath with at least one sidewall and a plurality of openings formed through the sidewall and a conduit portion at least partially circumscribed by the at least one sidewall. The exemplary method can include positioning a first hook within the conduit portion in a first position along a length of the flexible sheath adjacent a first opening in the sidewall. The first hook can be advanced relative to the sheath, or within the conduit portion to a second position further along the length of the flexible sheath than the first position. The first hook can be threaded through a second opening in the sidewall until the gape of the first hook has passed through the sidewall. A portion of the first hook can be retracted within the conduit portion until a portion of the sidewall of the sheath adjacent the second opening is contained within the throat of the first hook and the first hook is thereby secured to the sheath in the second position.

The method can further include disengaging the first hook from the sidewall of the sheath, advancing the first hook to a third position along the length of the flexible sheath and threading the first hook through a third opening in the sidewall until the gape of the first hook has passed through the sidewall. A portion of the first hook can then be retracted within the conduit portion until a portion of the sidewall of the sheath adjacent the third opening is contained within the throat of the first hook and the first hook is thereby secured to the sheath in the third position.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the examples.

I claim:

1. An adjustable tether for providing a connection between two points, the tether comprising:
a flexible sheath having:
at least one sidewall and a plurality of openings formed through the sidewall; and
a conduit portion at least partially circumscribed by the at least one sidewall;
an elastic member extending from a first portion of the sheath through the conduit portion of the sheath, and out of a first opening in the sidewall;
the elastic member and the flexible sheath each being elastically extendible from a retracted configuration having a retracted length to a taut configuration having a taut length, the taut length being greater than the retracted length;
the elastic member carrying at least one hook having a gape, a bend and a throat defined between the gape and the bend, the hook operable to engage a material of the sidewall adjacent the first opening to prevent or limit the hook from moving relative to the sidewall.

2. The tether of claim 1, wherein the conduit portion has a taut inner diameter when the sheath is in the taut configuration, the taut inner diameter being less than an outer diameter of the hook.

3. The tether of claim 1, wherein a size of the first opening is smaller when the sheath is in the taut configuration and expands when the sheath is in the retracted configuration.

4. The tether of claim 3, wherein both the taut size of the first opening and the retracted size of the first opening are smaller than the outer diameter of the hook.

5. The tether of claim 1, wherein the hook is formed of a substantially rigid material.

6. The tether of claim 5, wherein the gape of the hook is smaller than a maximum opening size of the throat of the hook.

7. The tether of claim 6, wherein the sidewall of the sheath includes a taut nominal thickness, and where the gape of the hook is smaller than the taut nominal thickness of the sidewall.

8. The tether of claim 1, wherein the elastic member carries a pair of hooks, each positioned on opposite ends of the elastic member.

9. An adjustable tether for providing a connection between two points, the tether comprising:
a flexible sheath having:
at least one sidewall and a plurality of openings formed through the sidewall; and
a conduit portion at least partially circumscribed by the at least one sidewall;
an elastic member extending from a first portion of the sheath through the conduit portion of the sheath, and out of a first opening in the sidewall;
the elastic member and the flexible sheath each being elastically extendible from a retracted configuration having a retracted length to a taut configuration having a taut length, the taut length being greater than the retracted length;
the elastic member carrying at least one hook formed from a substantially rigid material, the hook having a gape, a bend and a throat defined between the gape and the bend, the gape being smaller than a maximum opening size of the throat, the hook operable to engage a material of the sidewall adjacent the first opening to prevent or limit the hook from moving relative to the sidewall.

10. The tether of claim 9, wherein the sidewall of the sheath includes a tuat nominal thickness, and where the gape of the hook is smaller than the taut nominal thickness of the sidewall.

11. The tether of claim 9, wherein the elastic member carries a pair of hooks, each positioned on opposite ends of the elastic member.

12. A method of adjusting a retracted length of an adjustable tether, the tether having an elastic member and a flexible sheath with at least one sidewall and a plurality of openings formed through the sidewall and a conduit portion at least partially circumscribed by the at least one sidewall, the method including:
positioning a first hook within the conduit portion in a first position along a length of the flexible sheath adjacent a first opening in the sidewall;
advancing the first hook within the conduit portion to a second position further along the length of the flexible sheath than the first position;
threading the first hook through a second opening in the sidewall until the gape of the first hook has passed through the sidewall;
retracting a portion of the first hook within the conduit portion until a portion of the sidewall of the sheath adjacent the second opening is contained within the throat of the first hook and the first hook is thereby secured to the sheath in the second position.

13. The method of claim 12, further comprising:
disengaging the first hook from the sidewall of the sheath;
advancing the first hook to a third position along the length of the flexible sheath;
threading the first hook through a third opening in the sidewall until the gape of the first hook has passed through the sidewall;
retracting a portion of the first hook within the conduit portion until a portion of the sidewall of the sheath adjacent the third opening is contained within the throat of the first hook and the first hook is thereby secured to the sheath in the third position.

14. The method of claim 12, wherein the conduit portion has a taut inner diameter when the sheath is in a taut configuration, the taut inner diameter being less than an outer diameter of the first hook.

15. The method of claim 12, wherein a size of the first, second and third openings is smaller when the sheath is in the taut configuration and expands when the sheath is in the relaxed configuration.

16. The method of claim 15, wherein both the taut size and the retracted size of the first, second and third openings are smaller than an outer diameter of the first hook.

17. The method of claim 12, wherein the first hook is formed of a substantially rigid material.

18. The method of claim 12, wherein the gape of the first hook is smaller than a maximum opening size of the throat of the first hook.

19. The method of claim 18, wherein the sidewall of the sheath includes a taut nominal thickness, and where the gape of the first hook is smaller than the taut nominal thickness of the sidewall.

20. The method of claim 12, wherein the elastic member further comprises a second hook, the second hook engaging a portion of the sidewall of the sheath in a location removed along the length of the sheath from the first position.
